(19) United States
(12) Patent Application Publication
(10) Pub. No.: US 2023/0259098 A1
(43) Pub. Date: Aug. 17, 2023

(54) Apparatus and Method for Controlling a Safety-Critical Process

(71) Applicant: Pilz GmbH & Co. KG, Ostfildern (DE)

(72) Inventor: Michael SCHLECHT, Ostfildern (DE)

(21) Appl. No.: 18/303,339

(22) Filed: Apr. 19, 2023

Related U.S. Application Data
(63) Continuation of application No. PCT/EP2021/078524, filed on Oct. 14, 2021.

(30) Foreign Application Priority Data
Oct. 19, 2020 (DE) 102020127515

(51) Int. Cl. G05B 19/406

(52) U.S. Cl. CPC G05B 19/406; G05B 2219/50193

(57) ABSTRACT

A method for controlling a safety-critical process of a technical installation includes providing a first safe signaling unit and a second safe signaling unit that are connected to the safety-critical process via I/O channels. The method includes connecting the first safe signaling unit and the second safe signaling unit via a physical connection. The method includes implementing a safety-related communication protocol for failsafe data exchange on a logical level over the physical connection between the first signaling unit and the second signaling unit. The method includes exchanging data between the first safe signaling unit and the second safe signaling unit in a failsafe manner using the safety-related communication protocol to control the safety-critical process. The physical connection is implemented via a power supply network.

### CROSS-REFERENCE TO RELATED APPLICATIONS

This application is a continuation of PCT International Application No. PCT/EP2021/078524 filed Oct. 14, 2021. This application claims priority to German Application No. 10 2020 127 515.3 filed Oct. 19, 2020. The entire disclosures of the above applications are incorporated by reference.

### FIELD

The present disclosure relates to safety-critical process control in a technical installation and more particularly to an apparatus and method for using failsafe communication to control the safety-critical process.

### BACKGROUND

A safety-critical process can be any process from which an unacceptable danger to persons or objects emanates if a fault occurs. For safety-critical processes it must be ensured with ideally 100% certainty that the process will be transferred into a safe state when a fault occurs. For a machine installation, this may include shutting down the installation. For a chemical production process, on the other hand, this may include controlling the process into a non-critical parameter range, since simply shutting down the process could lead to an uncontrolled reaction.

Safety-critical processes can also be sub-processes of larger, higher-level processes. For a hydraulic press, for instance, the material feed can be a non-safety-critical sub-process, while the start-up of the press tool can be a safety-critical sub-process. Further examples of safety-critical (sub-)processes are the monitoring of safety guards, safety gates or light barriers, the control of two-hand switches or the monitoring and evaluation of an emergency stop switch. Controlling a safety-critical process basically comprises the steps of monitoring safety sensors or receiving other safety-related peripheral signals and triggering a safety-related reaction based on the monitoring or the received signals.

Individual units involved in the control of a safety-critical process must have safety-related equipment that goes beyond their actual function. These are primarily used for error and function monitoring. Generally, such units have a redundant design to ensure safe operation even in the event of a fault. Safe units with such safety-related equipment are hereinafter referred to as “safe” or “failsafe”, in contrast to “normal” standard units. Safe units are, in particular, safety components as defined in the Machinery Directive 2006/42/EC or the standard DIN EN ISO 13849-1.

In the early days of safety technology, safe units were linked with each other using dedicated wiring. The dedicated wiring was essentially implemented independently of the actual control of the technical installation. Generally, safe inputs, such as emergency stop switches, light barriers, etc., were linked to safe outputs via relay logic using independent, individual wiring in order to implement a safety function. In more modern systems, this hardwiring has increasingly been replaced by a more complex communication system with the aim of reusing the communication means generally known from control and automation technology for safety technology as well. For this purpose, either the known means of communication were enabled for the transmission of safety-critical data (e.g., SafetyNET P) or failsafe transmission via the existing means of communication was ensured by implementing specific safety protocols (e.g., FailSafe over Ethernet).

### SUMMARY

Inherently safe communication means have the advantage of allowing very flexible implementation of safety-related features, since safety is inherent in the communication means. However, safe communication means are more expensive and often need to be retrofitted to existing systems. The use of already existing communication means, such as a fieldbus system used for the control of a technical installation, is more favorable in contrast, but restricts the implementation options of a safety function to the existing communication means. However, existing communication means are not always available at the locations where safety-related facilities are needed. For example, an emergency stop switch can be located on a driven part that presents a hazard to a user, and not on the drive itself. It is therefore not uncommon for some safety functions to continue to be implemented via dedicated cabling, since the existing communication means for the normal control of the technical installation can be enabled for the transmission of safe data but are not always available where inputs and/or outputs for safety-related facilities are required.

It is an object to provide an apparatus and a method for controlling a safety-critical process, which allow a flexible design of a safety function. Furthermore, it is an object to specify an apparatus and a method that can be realized cost-effectively and can be easily integrated into existing systems.

According to one aspect of the present disclosure, there is provided an apparatus of the type mentioned above, wherein the physical connection is a power supply network.

Furthermore, there is provided a method for controlling a safety-critical process of a technical installation, comprising: providing a first safe signaling unit and a second signaling unit, which are connected to the safety-critical process via I/O channels; connecting the first safe signaling unit and the second safe signaling unit via a physical connection; implementing a safety-related communication protocol for failsafe data exchange on a logical level over the physical connection between the first signaling unit and the second signaling unit; exchanging data between the first safe signaling unit and the second safe signaling unit using the safety-related communication protocol to control the safety-critical process, wherein the physical connection is implemented via a power supply network.

Thus, it is an idea of the present disclosure to realize a link between safe units via a power supply network and not via a (data) communication network of the technical installation. A power supply network as defined in the present disclosure is a network for transmitting and distributing electrical power. It includes electrical lines set up to transmit electrical power to drive an electrical load. In contrast, a data communication network is a network whose primary task is the transmission of data.

Using power supply networks to link safe signaling units enables a user to implement safety technology independently of an existing control network of a technical installation. Consequently, the communication of safety facilities does not have to take place via the same communication infrastructure as the communication for the control of the technical installation for which the safety function is to be implemented. At the same time, however, the user does not have to carry out any new cabling to implement the safety function, as the cabling of an existing power supply network can be reused.

While a communication infrastructure for controlling a technical installation primarily takes into account control aspects of the technical installation, a power supply network is usually designed more universally and is therefore also available in areas where no control of the technical installation takes place, but which may be relevant from a safety perspective. For example, some safe signaling units are not located in the immediate vicinity of a machine's drives, but in areas where a user operates the machine. Wiring for system control is often not provided at these locations, but power supply network wiring may be accessible, for example, from lighting located in this area.

Using power supply networks for linking safe signaling units also requires little development effort, as both procedures for data transmission via power supply networks, so-called carrier frequency systems, and corresponding protocols for safety-related transmission are known. For example, communication via the power supply network can be carried out using the methods summarized under the name PowerLAN or Powerline Communications (PLC), for example, in accordance with one of the standards IEEE-1901-FFT, IEEE-1901-wavelet or ITU G.hn.

Safety-related communication at the logical level can be implemented using the so-called “black channel” principle. With the “black channel” principle, safety functions are realized on a separate safety layer on top of the actual transmission medium. This principle has been jointly developed with certifiers, such as the German TUV, and has been scientifically investigated and well validated. The “black channel” principle has already been used to enable standard fieldbuses or industrial Ethernet solutions for safety applications.

Overall, the proposed apparatus thus represents a simple, flexible and cost-effective way of implementing a safety function for a technical installation.

In a further refinement, the power supply network may provide a supply voltage for the technical installation.

According to this refinement, the power supply network via which the safe units communicate with each other is the same network that provides the electrical energy for the power supply of the technical installation. Existing cabling can thus be reused for the additional safe communication between safe signaling units, saving cabling and installation costs.

In a further refinement, the power supply network may provide a supply voltage for the first safe signaling unit and/or the second safe signaling unit.

According to this refinement, the first safe signaling unit and/or the second safe signaling unit supply themselves with electrical energy via the power supply network. In other words, on the one hand, a signaling unit can obtain a supply voltage from an existing wiring, and, on the other hand, the unit can transmit data signals using the same existing wiring. The power supply network can also provide the power supply independently of the voltage or frequency. This can be done, for example, via wide-voltage power supplies or universal power supplies with a high bandwidth of input voltage and frequency. This refinement thus contributes to simplified cabling overall, since only one connection is required for the power supply and for data transmission.

In a further embodiment, the power supply network between the first safe signaling unit and the second safe signaling unit may comprise at least one section implemented by a sliding contact, in particular a slip strip or a slip ring.

According to this refinement, communication can also be implemented in a simple manner via components moving relative to each other. This also enables retrofitting for devices where separate communication cabling is disadvantageous or not feasible. In case of a robot, for example, communication can be implemented across the individual joints without having to lay additional cables that restrict the robot's movement. This design can also be advantageously used for wind turbines in which the dome and mast are mounted so that they can rotate relative to each other and power is transmitted via slip rings.

In a further refinement, the first safe signaling unit may be arranged on a movable device of the technical installation and may be movable thereby relative to the second safe signaling unit.

According to this refinement, the signaling units may be coupled to (arranged on) devices that move with respect to each other. For example, a signaling unit can be arranged on the running crane element in an overhead crane system or on the respective means of transport in a guide-bound transport system. When power is supplied to the respective element, the same cabling can be used for safe communication between this signaling unit and another safe signaling unit connected to the same power supply network. This refinement thus contributes to further simplification of the cabling.

In a further refinement, the first safe signaling unit and the second safe signaling unit may each include communication means implementing a safety-related communication protocol for failsafe communication at the logical level and a standard communication protocol for normal communication over the physical link.

According to this refinement, the safe signaling units implement both, a safety-related communication protocol and a standard communication protocol.

The standard communication protocol can be a fieldbus or Ethernet-based communication protocol. The standard communication protocol should cover at least OSI reference model layers 1 and 2 (network access). In various embodiments, the standard communication protocol may comprise layers 1 through 7 of the OSI reference model. The safety-related communication protocol builds on the layers of the standard communication protocol and establishes a failsafe communication link at a logical level between the first safe signaling unit and the second safe signaling unit. Generic off-the-shelf solutions can be used for the implementation of the standard communication protocol. Available solutions are implemented on the basis of FPGAs, ASICs, stacks and modules on which the complete hardware and software for standard communication is integrated. Generic off-the-shelf solutions are also known for the implementation of the safety-related communication protocol, although not as numerous. In addition to modularization, the division into standard and safety communication has the advantage that, in accordance with the “black channel” principle, only the safety-related communication protocol has to undergo separate certification. If, in addition, the implementation of the safety-related communication protocol is encapsulated in a hardware and software component with corresponding interfaces, only this component has to go through the complex certification process. The division into two parts thus contributes to a cost-effective and flexible design of the overall apparatus.

In another refinement, the power supply network may be a DC network segment, particularly a 24/48 VDC network segment.

According to this refinement, communication takes place via a DC voltage network segment, as is regularly found in the industrial environment. The apparatus can thus make use of wiring commonly found in industrial environments. In addition, the safe signaling units can simply feed themselves from the DC voltage network segment without the need for rectification.

In another refinement, the power supply network may be an AC network segment, particularly a 230/400 VAC network segment.

An AC network segment is a part of almost every property and is regularly distributed over a large area. In addition, a large number of carrier frequency systems with sufficient transmission capacity and quality are available for common AC networks.

In a further refinement, the apparatus may further comprise a control unit configured to coordinate communication between the first safe signaling unit and the second safe signaling unit.

According to this refinement, another safe unit is provided as a control unit. The control unit has the same communication facilities as the first safe signaling unit and the second safe signaling unit. The control unit can communicate with the two signaling units and coordinate their communication. For example, the control unit can act as the communication master while other safe signaling units act as slaves. Communication between the safe signaling units can then be carried out indirectly via the control unit. The control unit can also set up addressing of the first signaling unit and the second signaling unit as well as other communication participants in order to realize even complex communication structures. The control unit can be connected to the power supply as a stand-alone communication unit or be a sub-component of one of the first or second signaling units. It is also conceivable that the function of the control unit can be flexibly and dynamically assigned to a particular safe signaling unit. Complex scenarios or communication structures can thus be realized via the control unit, allowing the apparatus to be used more flexibly overall.

In a further refinement, the apparatus may further comprise a switching unit configured to establish a safety-related communication between the first safe signaling unit and/or the second safe signaling unit and a system that is not connected to the power supply network via a data interface.

According to this refinement, the apparatus thus comprises a switching unit that can switch safety-related communication between two (safe) systems. For example, the switching unit can form a bridge between two networks, where the first network is the power supply network and the second network is a data communication network, such as a fieldbus or an industrial Ethernet network. The switching unit can be used to extend an existing network to include the units communicating within the power supply network. This refinement thus increases the application scenarios of the apparatus and facilitates the integration capability.

In a further refinement, the first safe signaling unit may be an input module, in particular an emergency stop module.

According to this refinement, the first safe signaling unit is an input module that receives signals from one or more signal transmitters (sensors). The signals can be transmitted in a failsafe manner via the physical connection with or without further signal processing, for example as an emergency stop signal. The signal transmitters can be, for example, light barriers, door switches, emergency stop buttons or other safe sensors known from safety technology. Using input modules in combination with data transmission via a power supply network allows flexible positioning of the safe sensors for implementing a safety function.

In a further refinement, the input module may further comprise a logic unit.

According to this refinement, the input module can not only accept data from signal transmitters, but also process it using processing logic. For example, the processing logic may link signals from multiple signal transmitters and generate an emergency stop signal based on link information. Thereby, even complex safety functions can be implemented in a simple manner.

In a further refinement, the second safe signaling unit may be an output module, particularly an output module having relay outputs or semiconductor-based outputs.

According to this refinement, the second safe signaling unit is an output module that controls the process via actuators connected thereto. The actuators can, for example, be contactors in a power supply of a drive of a technical installation, which only allow operation if a corresponding output signal is provided by the output module. The output signal can, for example, be fed from the power supply, which is provided by the power supply network. Furthermore, the signal, e.g. the emergency stop signal, based on which the output signal of the output module is generated, can also be received via the power supply network. The refinement therefore further simplifies the output wiring.

It is understood that the above features and those to be explained below can be used not only in the combination indicated in each case, but also in other combinations or on their own, without departing from the scope of the present disclosure.

### BRIEF DESCRIPTION OF THE DRAWINGS

Embodiments of the invention are shown in the drawings and are explained in more detail in the following description.

FIG. 1 shows an embodiment according to the present disclosure, in which two safe signaling units are connected to each other via a power supply network.

FIG. 2 shows a further embodiment comprising additional components that may be involved in safety-related communication via the power supply network.

FIG. 3 shows a schematic representation of an embodiment of a method according to the present disclosure.

### DETAILED DESCRIPTION

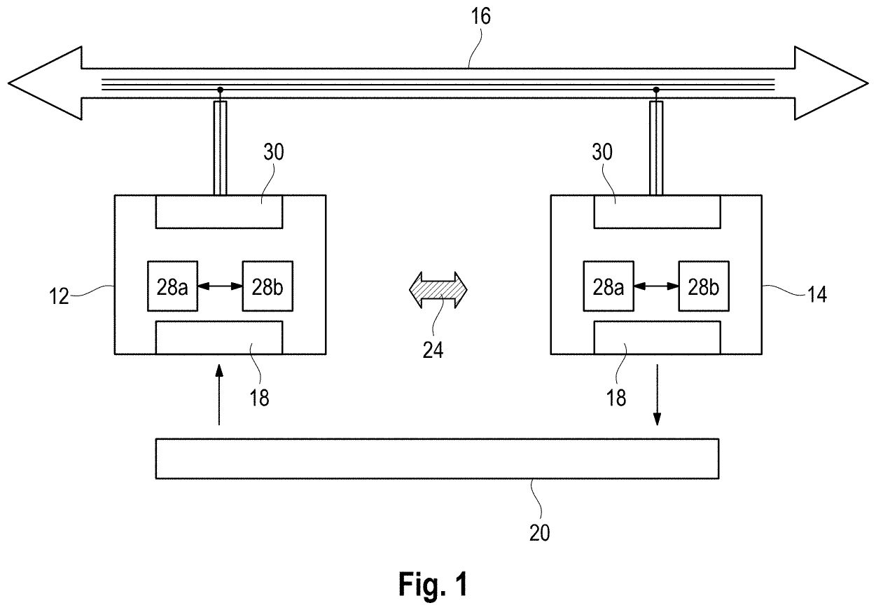

FIG. 1 shows an embodiment according to the present disclosure in which two safe signaling units are connected to each other via a power supply network. The apparatus is designated herein in its entirety by reference numeral 10 and includes at least a first safe signaling unit 12 and a second safe signaling unit 14.

The first safe signaling unit 12 and the second safe signaling unit 14 are coupled to each other via a power supply network 16, as will be discussed in further detail in the description below.

The first safe signaling unit 12 and the second safe signaling unit 14 each have one or more I/O channels 18 through which they are connected to a safety-critical process 20. The signaling unit 12, 14 read signals and/or data from the safety-critical process 20 via the I/O channels 18. Such signals or data are, for example, the switch position of an emergency stop switch or the current speed of a machine shaft. On the other hand, the signaling unit 12, 14 can act on actuators via the I/O channels 18 to control the safety-critical process 20.

In various embodiments, the safety-critical process 20 may be an emergency stop function. In this case, the first signaling unit 12 may be connected to an emergency stop switch and receive, as an input module, a signal representing the switch position of the emergency stop switch via the I/O channels 18. The second signaling unit 14, as an output module, may provide an output signal to the safety-critical process 20 via the I/O channels 18. The output signal can be an enable signal, which allows operation of the technical installation only if this signal is present. For example, the enable signal can act on an actuator that can be used to switch off the main power supply to the technical installation.

The first safe signaling unit 12 and the second safe signaling unit 14 are connected to each other via a power supply network 16. That is, the first signaling unit 12 and the second safe signaling unit 14 are in contact with one or more conductors 22 of a power supply network 16 which distributes power. The conductors may be, for example, individual outer conductors (phases) of a 230/400V AC power supply network or, alternatively, the wires of a DC power supply network, for example, a 24V DC power supply network such as is regularly found in an industrial environment. The first safe signaling unit 12 and the second safe signaling unit 14 can receive a supply voltage from the power supply network 16.

Further, the first safe signaling unit 12 and second safe signaling unit 14 may be arranged as, or coupled to, a so-called carrier frequency unit to transmit data via the designated contact over the power supply network 16. Carrier frequency units use carrier frequency technology to exchange data over existing transmission paths that are generally designed for a different purpose. For this purpose, the signals to be transmitted are modulated onto a conductor 22 of the power supply network 16 via one or more carrier frequencies. Carrier frequency technology in power supply networks is also known as PowerLAN or Powerline communications and is described in various standards.

The communication between the first signaling unit 12 and the second signaling unit 14 is set up as a safe communication 24 (also referred to as failsafe (FS) communication or safety-related communication). According to this disclosure, the term “safe communication” means that data can be transmitted in a failsafe manner in terms of machine safety. Since such communication cannot generally be realized by the previously described data communication means for power supply networks 16, the safe communication 24 between the signaling unit 12, 14 according to the present disclosure takes place at a logical level above the actual communication layer using a “black channel” principle.

“Black channel” in communications technology refers to using a communications channel with properties that are unsecured or not suitable for the application. The “black channel” principle makes it possible to meet an application's requirement for communication without the communication channel ensuring this. For this purpose, a safety protocol is implemented using a safety application and a non-safe communication channel. The safety protocol ensures the desired safety level of a safety-oriented system and detects and controls transmission errors of the underlying communication layers.

For implementing the safety protocol, the first safe signaling unit 12 and the second safe signaling unit 14 may each have safety-related equipment 26 by means of which the protocol is implemented. In the embodiment according to FIG. 1, the safety-related equipment 26 is indicated by two processing units 28a, 28b. The two processing units 28a, 28b may perform safety-related tasks redundantly to each other. In doing so, they can control each other, which is indicated in FIG. 1 by the double arrow between the processing units 28a, 28b. In addition to implementing the safety protocol, the safety-related equipment 26 may perform other safety-related tasks, such as safely linking signals or executing a safety-related user program.

The hardware and software for implementing the safety protocol may be encapsulated into a standalone module. This module can be implemented separately from a communication module 30, which implements the “unsafe” communication via the power supply network 16. The “standard” communication module 30 may be a standard component that implements the carrier frequency technology described above.

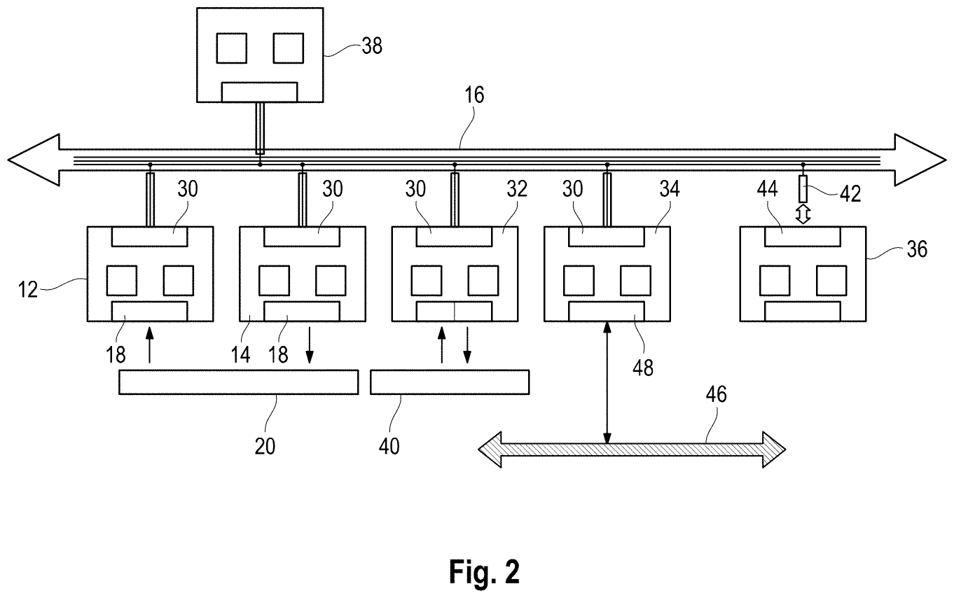

FIG. 2 shows an embodiment in which additional components supplement and extend the system described above.

In addition to the first signaling unit 12 and the second safe signaling unit 14, the apparatus according to the embodiment of FIG. 2 comprises two further signaling units 32, 36, a switching unit 34 and a control unit 38. All units 12, 14, 32, 34, 36, 38 are coupled to one another in the manner described above via the power supply network 16 and are configured to exchange data in a failsafe manner via the power supply network 16. Thus, the units each have a communication module 30 for “unsafe” communication over the power supply network 16, and safety-related equipment 26 for implementing a safety protocol that ensures safe transmission over the unsafe communication channel.

The first signaling unit 12 and the second safe signaling unit 14, which have already been explained with reference to FIG. 1, are not described again below. The same applies to other components already described with reference to FIG. 1. The same reference signs for these components have been used in FIG. 2.

The safe signaling unit 32 is substantially the same as the previously described safe signaling units 12, 14, differing in that it has both inputs and outputs to a process 40. The signaling unit 32 thus combines the functions of the safe signaling units 12, 14 and integrates them into a single unit. In addition, the safe signaling unit 32 can have a logic unit that implements a safe linking of the input signal and the output signal.

The further safe signaling unit 36 is configured essentially in the same way as the safe signaling units 12, 14 described above, differing only in its connection to the power supply network 16, which is designed here as a separate connection unit 42. The connection unit 42 may be a commercially available PowerLAN adapter that converts, for example, Ethernet-based communications for transmission over the power supply network 16. Accordingly, the safe signaling unit 36 may include a communication module 44 that implements an ordinary communication network interface. For example, the communication module 44 may be an Ethernet interface. In this way, existing hardware of a safe signaling unit can reused, since only the safety protocol needs to be implemented. This can be done on the basis of a software change/update.

The switching unit 34 represents a further communication subscriber/participant that is configured to act as a broker between two networks. As an example, a field bus 46 is indicated here as a second network in addition to the power supply network 16. The switching unit 34 mediates between the two networks 16, 46 like a bridge. For this purpose, it has the previously described communication module 30 for communication via the power supply network 16 and, in addition, a communication module 48 for communication via the field bus 46. Furthermore, the switching unit 34 extends the safety protocol in such a way that data telegrams or signals received via the communication module 30 are forwarded via the communication module 48 to units connected to the field bus 46 or vice versa.

In addition to linking two different communication networks, a switching unit 34 in another embodiment may also be configured to couple two different types of power supply networks for data communication. In this way, signaling units coupled, for example, on a 24 VDC network can communicate with units coupled on a 230/400 VAC network.

Generally, the apparatus can include other coupling elements that provide further transmission paths. For example, a phase coupler can be provided to connect two outer conductors for the transmission of carrier signals. Outer conductors are generally understood to be the conductors in a power supply network that are live (under voltage) during normal operation and contribute to the transmission or distribution of electrical energy. The phase coupler connects the outer conductors in such a way that the voltages remain separated, but the high-frequency carrier signal, which enables data communication, is transmitted from one outer conductor to the other. Thereby, for example, each conductor of a three-phase AC network can be used for data transmission.

Furthermore, FIG. 2 shows a control unit 38 configured to coordinate communication within the power supply network 16. For example, the control unit 38 may be set up as a master station and the other units each as a slave. Thereby, different communication modes can be realized. In addition, the control unit 38 may also perform other coordination tasks familiar from communication technology. For example, the control unit 38 may coordinate central address allocation and assignment.

Like the other signaling units 12, 14, the control unit 38 may have a “standard” communication module 30 and safety-related equipment 26 for implementing the safety protocol.

The safety-related equipment 26 of the control unit 38 may further be used to execute a (safe) user program to implement a desired safety function. In this case, the other signaling units can be set up as simple input modules and/or output modules that are remote from the control unit 38 and connect it to the process that is to be controlled. The control unit 38 may further be configured to process the data which has been transmitted via the power supply network 16 centrally in a failsafe manner.

While the control unit 38 and the switching unit 34 are shown here as independent units, their functions can be integrated into any one of the signaling units described above. It is also conceivable that the role of the control unit 38 is delegated to one of the signaling units dynamically when the network is set up. Furthermore, a dynamic reconfiguration may take place as soon as the participants in the network change.

In principle, the network shown in FIG. 2 is to be understood as an example only. The person skilled in the art is aware that possible modules are shown here in principle, which can also be combined in a different way and in a different number to represent a safety function. Furthermore, the skilled person recognizes that the network is not only set up for safety-related tasks, but may also process standard automation tasks in parallel to this by integrating the corresponding components into the network.

Therefore, the proposed apparatuses may be used to easily expand existing facilities. In particular, areas that were previously only accessible via the power supply network can be covered by the new apparatus.

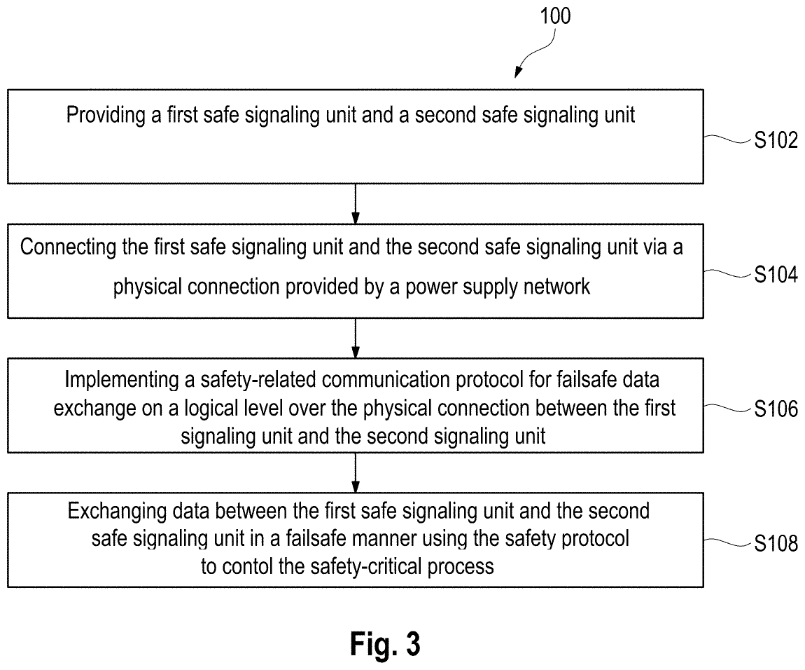

FIG. 3 shows in a schematic representation a method according to an embodiment of the present disclosure.

The method 100 controls a safety-critical process 20 and includes providing a first safe signaling unit 12 and a second safe signaling unit 14 connected to the safety-critical process 20 via I/O channels 18 (S102).

The safe signaling unit 12, 14 are coupled to each other via a physical connection. The physical connection is implemented via a power supply network 16 (S104). Coupling with the power supply network 16 can be done, for example, by plugging the signaling units 12, 14 into an outlet (electrical socket) of the power supply network 16. In addition to the connection to the power supply network 16, the signaling units 12, 14 may only have additional connections to the peripherals (I/O ports).

Furthermore, the first safe signaling unit 12 and the second safe signaling unit 14 each implement a safety protocol for ensuring a data exchange on a logical level between the two signaling units (S106) in a failsafe manner.

Based on the safety protocol, the first safe signaling unit 12 and the second safe signaling unit 14 exchange data with each other in a failsafe manner to control the safety-critical process 20 (S108).

It is understood that the process steps described here only represent the essential elements of the process. Further steps may be included in between the aforementioned process steps. In addition, a more complex network can also be represented by further process steps, as previously described with reference to FIG. 2.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

What is claimed is:

1. An apparatus for controlling a safety-critical process of a technical installation, the apparatus comprising:
a first safe signaling unit; and
a second safe signaling unit, wherein:
the first safe signaling unit and the second safe signaling unit are connected to the safety-critical process via I/O channels,
the first safe signaling unit and the second safe signaling unit are configured to communicate with each other in a failsafe manner via a physical connection on a logical level to control the safety-critical process, and
the physical connection is a power supply network.

2. The apparatus of claim 1 wherein the power supply network provides a supply voltage for the technical installation.

3. The apparatus of claim 1 wherein the power supply network provides a supply voltage for at least one of the first safe signaling unit and the second safe signaling unit.

4. The apparatus of claim 1 wherein the power supply network includes, between the first safe signaling unit and the second safe signaling unit, at least one section implemented by a sliding contact.

5. The apparatus of claim 4 wherein the sliding contact includes at least one of a slip strip and a slip ring.

6. The apparatus of claim 1 wherein the first safe signaling unit is arranged on a movable device of the technical installation and is thereby configured to be movable relative to the second safe signaling unit.

7. The apparatus of claim 1 wherein the first safe signaling unit and the second safe signaling unit each include a communication system that implements:
a safety-related communication protocol for failsafe communication on the logical level; and
a standard communication protocol for standard communication over the physical connection.

8. The apparatus of claim 1 wherein the power supply network includes a DC network segment.

9. The apparatus of claim 8 wherein the DC network segment is a 24 VDC network segment.

10. The apparatus of claim 1 wherein the power supply network includes an AC network segment.

11. The apparatus of claim 10 wherein the AC network segment is a 230/400 VAC network segment.

12. The apparatus of claim 1 further comprising a control unit configured to coordinate communication between the first safe signaling unit and the second safe signaling unit.

13. The apparatus of claim 1 further comprising a switching unit configured to establish a failsafe communication between (i) a system that is not connected to the power supply network via a data interface and (ii) at least one of the first safe signaling unit and the second safe signaling unit.

14. The apparatus of claim 1 wherein the first safe signaling unit is an input module.

15. The apparatus of claim 14 wherein the input module is an emergency stop module.

16. The apparatus of claim 15 wherein the input module includes a logic unit.

17. The apparatus of claim 1 wherein the second safe signaling unit is an output module.

18. The apparatus of claim 17 wherein the output module includes at least one of relay outputs and semiconductor-based outputs.

19. A method for controlling a safety-critical process of a technical installation, the method comprising:
providing a first safe signaling unit and a second safe signaling unit that are connected to the safety-critical process via I/O channels;
connecting the first safe signaling unit and the second safe signaling unit via a physical connection;
implementing a safety-related communication protocol for failsafe data exchange on a logical level over the physical connection between the first signaling unit and the second signaling unit; and
exchanging data between the first safe signaling unit and the second safe signaling unit in a failsafe manner using the safety-related communication protocol to control the safety-critical process,
wherein the physical connection is implemented via a power supply network.
